(19) United States
(12) Patent Application Publication
(10) Pub. No.: US 2019/0083348 A1
(43) Pub. Date: Mar. 21, 2019

(54) Axial Spinal Decompression and Traction Device

(71) Applicant: Glenn Dugger, London, OH (US)

(72) Inventor: Glenn Dugger, London, OH (US)

(21) Appl. No.: 16/130,190

(22) Filed: Sep. 13, 2018

Related U.S. Application Data
(60) Provisional application No. 62/560,382, filed on Sep. 19, 2017.

(51) Int. Cl. A61H 1/02

(52) U.S. Cl. CPC A61H 1/0218; A61H 2201/1621; A61H 2203/0456; A61H 1/0292

(57) ABSTRACT

The exemplary embodiments herein provide a back therapy device as well as a kit for a back therapy device containing an elongate member having a first end and a second end, a pair of flexible bands, each band forming a continuous loop, and a belt. Exemplary embodiments also provide a pair of base elongate members, a pair of extension elongate members, a pair of straight couplers, a connecting elongate member, and a pair of elbow couplers. Alternative embodiments may use a telescoping mechanism in place of the straight couplers. Some embodiments also use a cross-plate to secure the extension elongate members relative to one another.

### CROSS-REFERENCE TO RELATED APPLICATIONS

This application claims priority to US Provisional Application No. 62/560,382 filed on Sep. 19, 2017 which is herein incorporated by reference in its entirety.

### TECHNICAL FIELD

Embodiments generally relate to devices for treating various back conditions.

### BACKGROUND OF THE ART

Many people develop painful symptoms in their back at some point during their life, either through a traumatic injury, a debilitating disease, or general wear and tear on your back as you age. Whether the pain is acute or chronic, these symptoms can have a devastating impact on someone's mobility, quality of life, ability to earn a living, and ability to raise their family. In some cases, surgery is required to help relieve the pain, but this option is both expensive and quite risky in many cases.

Spinal decompression and lower back traction have been found to produce natural (i.e. no chemicals/pharmaceuticals/surgery) relief of the symptoms and aid recovery. However, devices which can accomplish this feat are known to be expensive, difficult to use, or require a visit to a medical office. There is a large demand for inexpensive devices for spinal decompression and lower back traction that can be used in the home and can be easily assembled/disassembled for travel.

### SUMMARY OF THE EXEMPLARY EMBODIMENTS

Exemplary embodiments provide a device for spinal decompression and lower back traction which can be used anywhere having a floor that meets a wall. The device is designed to lie flat against the floor and press horizontally against a wall. A belt is worn by the user which translates an axially decompressive force from the device to the user while the user simply lies atop the device. In this way, the user is in a very relaxed position where they can enjoy the benefits of decompression and traction for long periods of time without the fatigue that can be produced in other devices. The device can be easily assembled/disassembled in to a light and small package for initial shipping and travel by the user.

The device can be used in many ways by the user, to either provide a relatively constant axially decompressive force or to vary the amount of force over time. The user is free to move their arms, torso, and legs which can increase the stretching, decompression, and traction effects of the device and allows the user to perform therapy exercises while receiving spinal decompression.

The foregoing and other features and advantages of the present invention will be apparent from the following more detailed description of the particular embodiments, as illustrated in the accompanying drawings.

### BRIEF DESCRIPTION OF THE DRAWINGS

A better understanding of an exemplary embodiment will be obtained from a reading of the following detailed description and the accompanying drawings wherein identical reference characters refer to identical parts and in which:

FIG. 1 is a perspective view of an exemplary embodiment of the axial spinal decompression and traction device.

FIG. 2 is an exploded view of another exemplary embodiment of the device, showing some optional components.

FIG. 3 is a front elevational view of the embodiment from FIG. 1.

FIG. 4 is a top plan view of the embodiment from FIG. 1, showing the device in a compressed and in an extended condition.

FIG. 5A is a perspective illustration of the embodiment from FIG. 1, where the device has been positioned on the floor for use.

FIG. 5B is a perspective illustration of the embodiment from FIG. 1, where the user has positioned themselves for use by lying atop the device.

FIG. 5C is a perspective illustration of the embodiment from FIG. 1, where the user has positioned the hip belt around their hips and attached the belt to the device.

FIG. 5D is a perspective illustration of the embodiment from FIG. 1, where the device is being used for spinal decompression and lower back traction.

FIG. 6 is a right side elevation view of the embodiment of the device shown in FIG. 2.

FIG. 7 is a top plan view of another alternative embodiment of the axial spinal decompression and traction device.

FIG. 8 is a top plan view of a further alternative embodiment of the axial spinal decompression and traction device.

FIG. 9 is a top perspective view of a further alternative embodiment of the axial spinal decompression and traction device.

### DETAILED DESCRIPTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

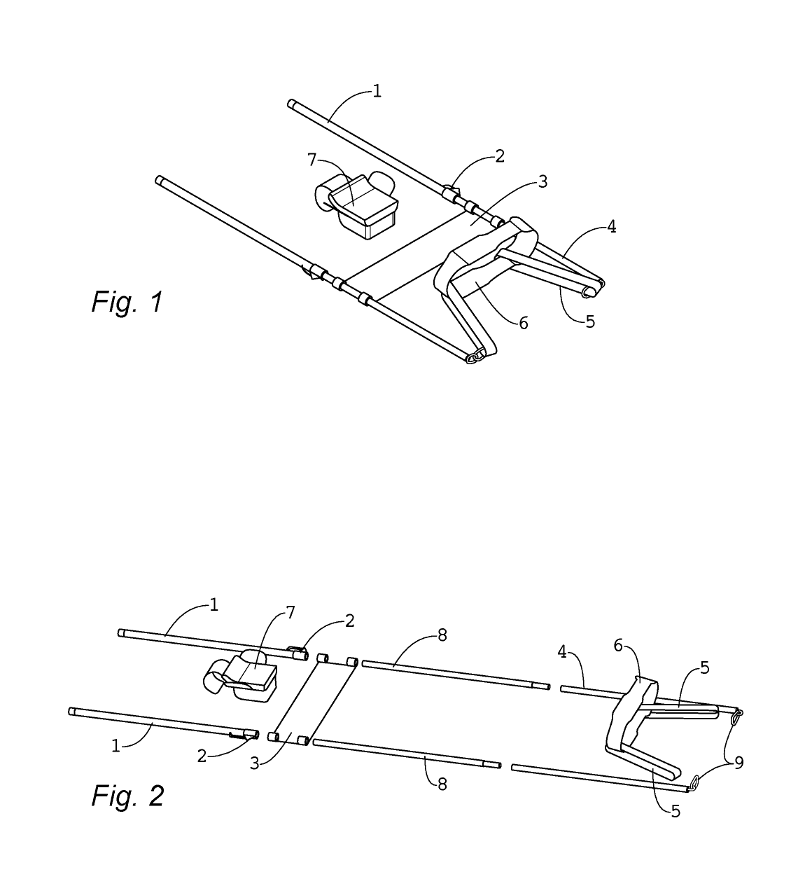

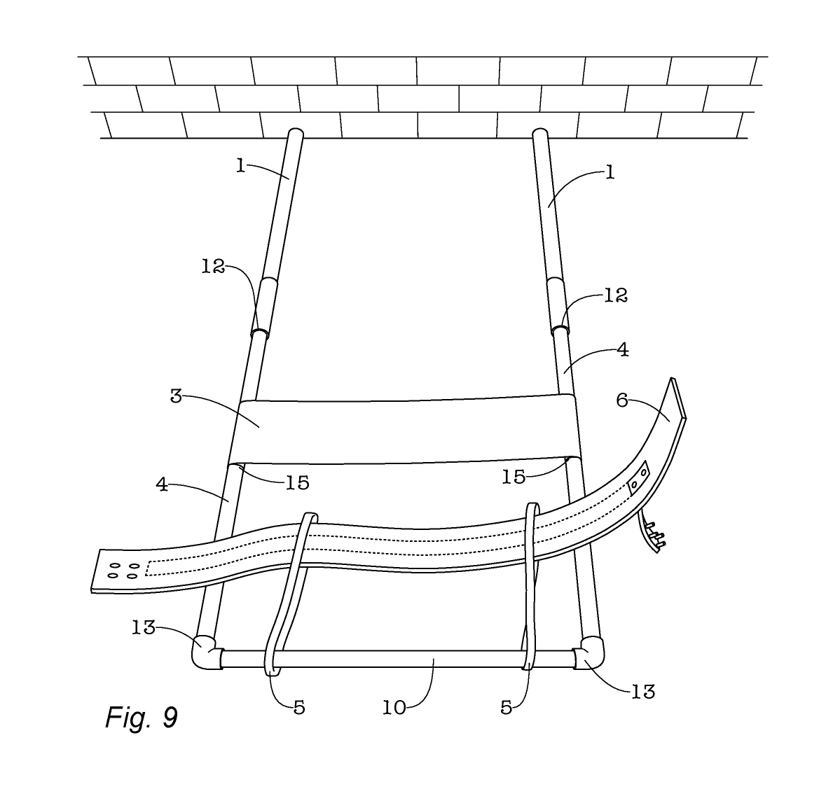

FIG. 1 is a perspective view of an exemplary embodiment of the device. A pair of base elongate members 1 are spaced apart and generally parallel to one another, with a first end that is adapted for positioning against a wall. The base elongate members 1 then preferably contain an opposing second end which is adapted to accept/enter the extension member 4 (if used and/or necessary). The opposing second end of the base elongate members 1 should also engage with a telescoping or locking mechanism 2, for securing the extension member 4 to the base elongate member 1 at a desired orientation. In some embodiments, the extension member 4 is secured to the outside of or alternatively within the interior portion of the base elongate member 1 at varying orientations (i.e. various depths and angles, or sometimes just various depths). However, in other embodiments a telescoping or locking mechanism would not be used, instead a straight coupler 12 would be used similar to the embodiment shown in FIG. 9.

The pair of extension members 4 are preferably separated by a cross-plate 3, which contains a pair of apertures for accepting each of the extension members 4, and preferably holding them in a spaced position relative to one another.

Each of the extension members 4 should comprise an elongate member which preferably contains a pair of opposing ends with a first end that is adapted to be secured with the telescoping or locking mechanism 2 and a second opposing end that attaches to a flexible strap or band 5. As will be shown and described further below, the band 5 may connect directly to the extension member 4 or may be connected through an intermediary connecting member. As shown, the band 5 can be a continuous loop of material (similar to a common rubber band) or alternatively could be a flexible elongate member having a pair of opposing ends with one end attached to the extension member 4 and the opposing end attached to the belt 6. Otherwise, as shown in the figure, the band 5 can be a continuous loop with a first portion attached to the extension member 4 and a second portion attached to the belt 6.

An optional head rest or neck support 7 is preferably positioned on the floor and between the wall and the cross-plate 3, to support the head/neck of the user while using the device. The neck support 7 can contain many different types of features and materials, but essentially provides an elevated surface above the ground for support of the back of the user's head or neck region. The neck support 7 is generally placed equidistant between the two base elongate members 1. The neck support 7 should have a surface on the bottom which will provide enough friction force to ensure that the neck support 7 will not slide along the floor. The neck support 7 is not necessary to practice the invention, only optional.

FIG. 2 is an exploded view of another exemplary embodiment of the device, showing some optional components. Here, an optional intermediary extension member 8 is used to extend the maximum length that the device can extend to, while ensuring that components remain under a length threshold for shipping, to ensure small packaging for shipment, along with easy collapsibility for travel. The intermediary extension member 8 should connect at a first end with the telescoping or locking mechanism 2 and at an opposing second end with the extension member 4. In some embodiments, the diameters of the extension member 4 and the intermediary extension member 8 would be substantially the same, with a small portion at the opposing second end of the intermediary extension member 8 which would contain a smaller diameter, designed to fit within the extension member 4. In some embodiments, the extension member 4 may connect with the intermediary extension member 8 with threads (i.e. one end of the intermediary extension member 8 would be threaded into one end of the extension member 4, or vice versa).

Also shown here is the optional clip 9 for attaching the flexible band 5 with the extension member 4. As noted above, the clip 9 may be used, or alternatively the band 5 could attach directly to the extension member 4 by having a clip or ledge formed as part of the extension member 4. The clip 9 could be comprised of many types of materials, including but not limited to metals and plastics, and may or may not include a spring-lock similar to a carabiner. In some embodiments, the clip 9 would be a simple “C” shape with no spring-lock, but only a pair of opposing attachment features to attach with the band 5 and extension member 4.

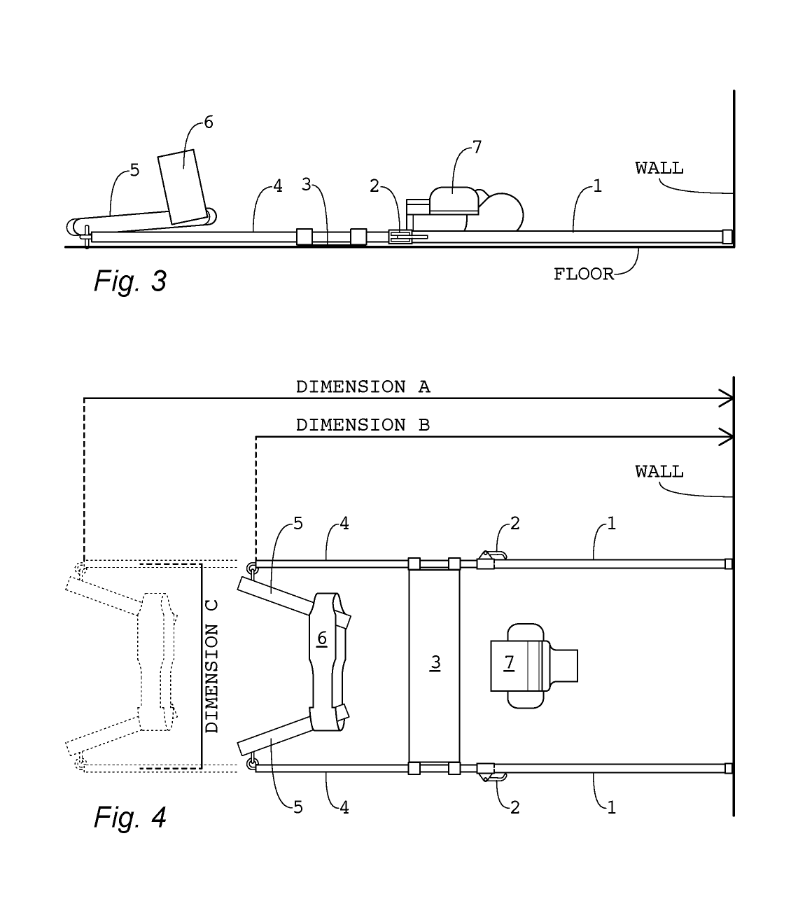

FIG. 3 is a front elevational view of the embodiment from FIG. 1. Preferably, the base elongate members 1, extension members 4, and the cross-plate 3 are adapted to be positioned flat against the floor. The cross-plate 3 may contain a central portion which is substantially flat and adapted to be positioned behind the back of the user (near the shoulder blades) and sandwiched between the user's back and the floor. On the outer edges of the central portion of the cross-plate 3, apertures may be placed for accepting the extension members 4 (or base members 1 if extension members 4 are not used). In this way, the cross-plate 3 may be described has holding a fixed distance between the extension members 4 (or base members 1) and/or temporarily fixing them in a substantially parallel orientation to one another. Once assembled, the extension members 4 (or base members 1) may be fixed relative to the cross-plate 3 or alternatively the extension members 4 (or base members 1) may still be permitted to slide/rotate relative to the cross-plate although still held in a substantially parallel orientation. The optional head rest 7 should also preferably remain flat against the floor.

FIG. 4 is a top plan view of the embodiment from FIG. 1, showing the device in a compressed (indicated with solid lines) and in an extended (indicated with broken lines) condition. First, the compressed condition of the device is shown, where the extension members 4 have been moved towards the base elongate members 1. In this particular embodiment, the telescoping or locking mechanism 2 has been released and the extension members 4 have been translated into the base members 1 as far as possible.

Dimension B represents the distance between the wall (or first end of the base member 1) to the opposing end of the device (the end of the extension member 4 which opposes the wall and connects to the band 5) when the device is in the compressed condition. It has been found that approximately 50 inches-60 inches will provide an acceptable range for Dimension B, with approximately 56 inches being the most preferred.

Second, the extended condition of the device is shown, where the extension members 4 have been moved away from the base elongate members 1. In this particular embodiment, the telescoping or locking mechanism 2 has been released and the extension members 4 have been translated out of the base members 1 as far as generally possible or desirable.

Dimension A represents the distance between the wall (or first end of the base member 1) to the opposing end of the device (the end of the extension member 4 which opposes the wall and connects to the band 5) when the device is in the extended condition. It has been found that approximately 70 inches-80 inches will provide an acceptable range for Dimension A, with approximately 76 inches being the most preferred.

Dimension C represents the distance between the centerlines of the base members 1 and extension members 4 (which are preferably axially aligned). It could be generally referred to as the overall width of the device for accepting the body of the user. It has been found that approximately 20 inches-30 inches will provide an acceptable range for Dimension C, with approximately 24 inches being the most preferred. Dimension C is generally determined by the length of cross-plate 3, which in some embodiments could be adjustable in length (ex. between 20 inches and 30 inches), thus providing an adjustment for the overall device's width for both (1) different sizes of users as well as (2) able to obtain small-volumes in packing for reduced shipping costs and portability for the user. The optional head rest 7 is generally placed equidistantly between the two base members 1.

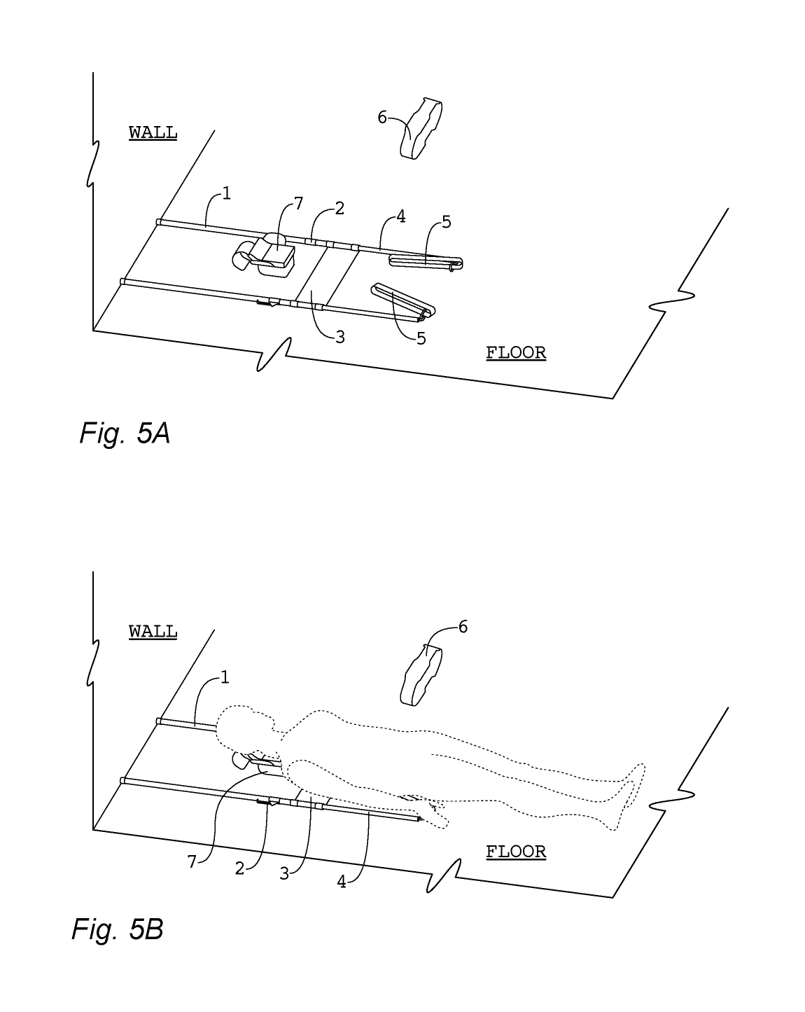

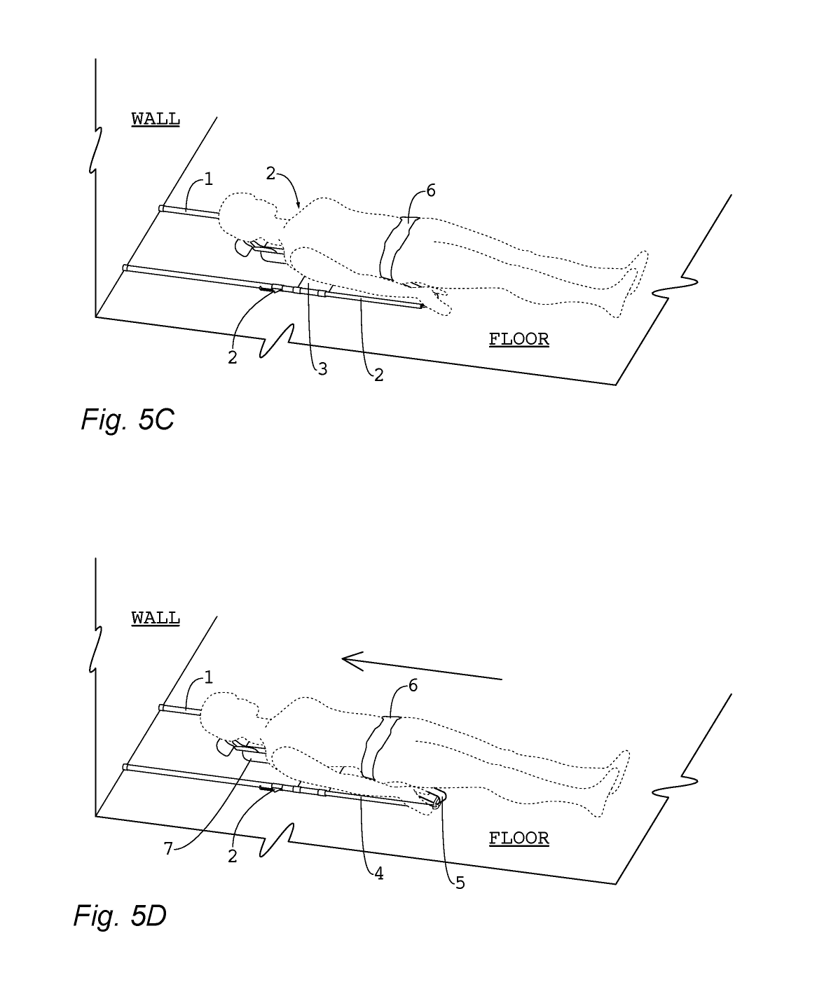

FIG. 5A is a perspective illustration of the embodiment from FIG. 1, where the device has been positioned on the floor for use. As indicated above, the user orients the device such that a first end of the base members 1 will contact the wall and lay horizontally against the floor. Similarly, the extension members 4 engage with the cross-plate 3 to also lay flat against the floor and provide the proper spacing between the members 1 and 4. The extension members 4 should then be engaged with the telescoping or locking mechanism 2 once the proper overall length of the device has been chosen (see Dimension A and Dimension B above), in order to hold the device in the compressed condition, extended condition, or at various points in between, depending on the height of the user. As noted below, in an alternative method, the user can wait to adjust the extension members 4 until the user is lying on the device in the proper position. Of course, a user could also adjust the extension members 4 both prior to lying on the device and after lying on the device and wearing the belt 6 as well.

During this initial setup step, the bands 5 should also be attached to the extension members 4 (if not already attached) and the optional head rest 7 should be positioned in the desired location, depending on the height of the user.

FIG. 5B is a perspective illustration of the embodiment from FIG. 1, where the user has positioned themselves atop the device. The user can adjust the overall length of the device by adjusting the length of the extension members 4 and re-securing the telescoping or locking mechanism 2.

FIG. 5C is a perspective illustration of the embodiment from FIG. 1, where the user has positioned the belt 6 around their hip area and is making any final adjustments (if necessary) by adjusting the length of the extension members 4 and re-securing the telescoping or locking mechanism 2. In some methods, the user may adjust the extension members 4 in this way until there is some tension on the bands 5 (which can be felt in the belt 6). It should be noted that the apertures on the cross-plate 3 should allow the extension members 4 to slide relative to the cross-plate 3, which allows the user to lay on the central portion of the cross-plate 3 while being able to adjust the overall length of the device or the amount of tension on the bands 5.

FIG. 5D is a perspective illustration of the embodiment from FIG. 1, where the device is being used for spinal decompression and lower back traction. During use, the primary movement by the user should be a horizontal translation towards the wall. As the user translates towards the wall, the belt 6 will become farther and farther away from the attachment point with the extension members 4, which causes a load to build-up in the bands 5. This load is translated to the belt 6 through the attachment with the bands 5, which creates a gentle and flexible downward force (away from the wall) on the hips of the user. This force away from the wall is resisted by a combination of (1) the friction force between the user and the floor and (2) the friction force between the head rest 7 and the floor. To increase the load in the bands 5 (or downward force on the hips), the user simply slides closer to the wall, until the desired amount of force in the bands 5 has been achieved. In some cases, the user may place a pad (ex. yoga pad) on the floor for comfort, positioned between the members 1 and 4, which can also help the friction force between the floor and the user to prevent the user from sliding once in the desired position. This may be used where the user is operating the device on a floor with a slick surface such as a wood, tile, or stone floor.

From here, the user can simply rest and allow a relatively-constant amount of spinal decompression for as long as they desire. At this point the user can also place (or relocate) the head rest 7 in a comfortable location. The user can increase/decrease the load in the bands 5 (i.e. move closer to or further from the wall) in cycles to add/remove the amount of spinal decompression, as this has been found to be particularly therapeutic for some users that suffer from degenerative or ruptured discs in their spine. The user can raise their arms above their head or twist their torso, to further increase the stretching, decompression, and traction effects. Additionally, the user can move and rotate their hips and legs to further increase the stretching, decompression, and traction effects.

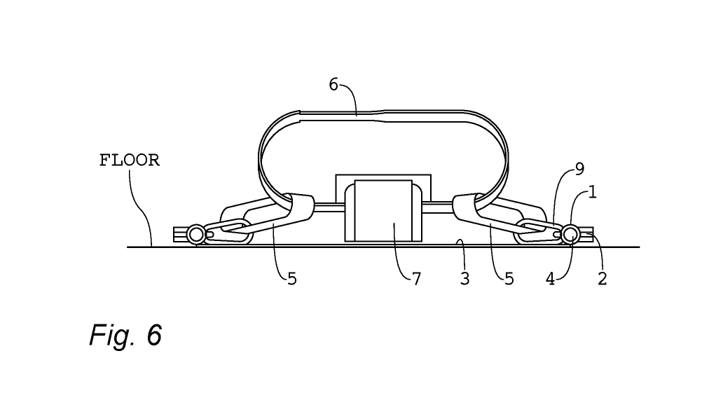

FIG. 6 is a right side elevation view of the embodiment of the device shown in FIG. 2. Shown here again is the optional clip 9 for attaching the flexible band 5 with the extension member 4.

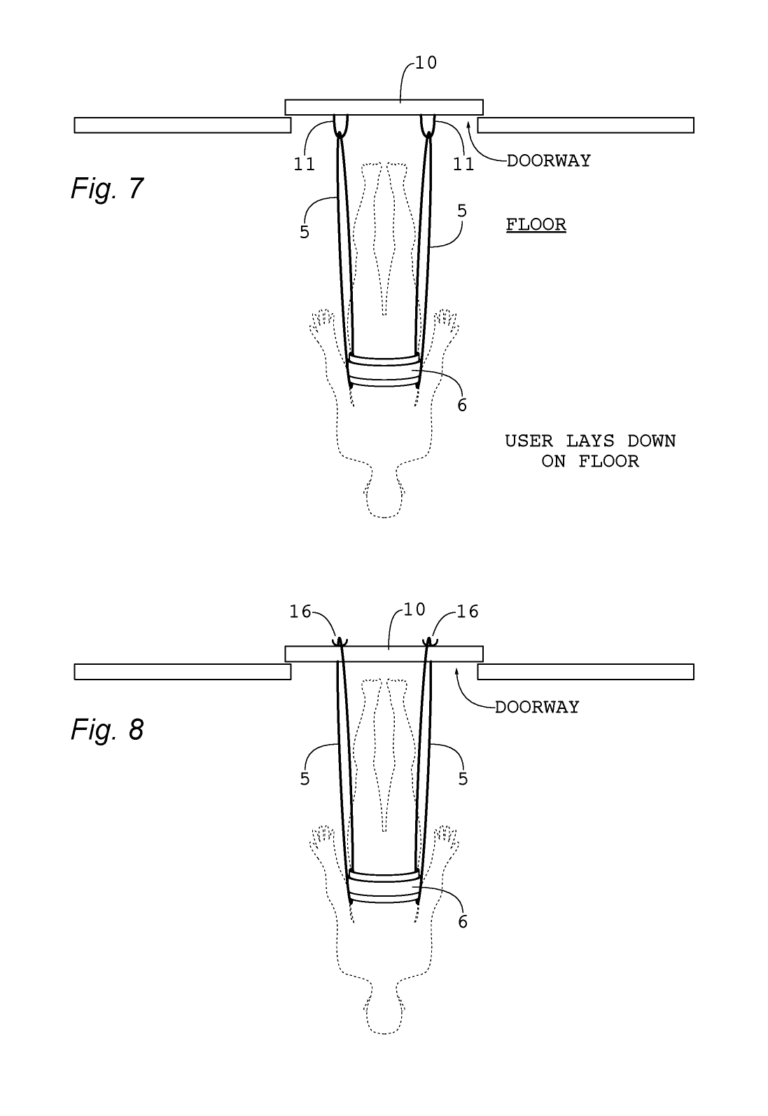

FIG. 7 is a top plan view of another alternative embodiment of the axial spinal decompression and traction device. In this embodiment, a door opening is used as the anchor point for the device, as opposed to a wall or vertical surface in the embodiments above. A connecting elongate member 10 spans across a door opening with some overlap with the door opening on each end. In other words, the length of the connecting elongate member 10 should exceed the width of the door opening by at least 10%, with additional length of the connecting elongate member 10 being preferable, for safety or for use with larger door openings. In some embodiments, the connecting elongate member 10 may be 10-20 inches longer than the width of the door opening. In a preferred embodiment, the connecting elongate member 10 would also be adjustable for use with door widths of varying sizes, as well as the ability to collapse the device for transport and shipping.

In this embodiment, the connecting elongate member 10 may have at least two attachment points 11 for attaching the bands 5 to the connecting elongate member 10. A clip can be used similar to clip 9 and could be comprised of many types of materials, including but not limited to metals and plastics, and may or may not include a spring-lock similar to a carabiner. In some embodiments, the clip used with the attachment points 11 would be a simple “C” shape with no spring-lock, but only a pair of opposing attachment features to attach with the band 5 and connecting elongate member 10.

When using this embodiment, no cross-plate may be used. The user would lie in an opposite orientation as compared to the embodiments above. Here, the user's head would be positioned away from the door opening rather than adjacent to the wall.

During use, the primary movement by the user (to increase the load on the bands 5) should be a horizontal translation away from the door opening. As the user translates away from the door opening, the belt 6 will become farther and farther away from the connecting elongate member 10, which causes a load to build-up in the bands 5. This load is translated to the belt 6 through the attachment with the bands 5, which creates a gentle and flexible downward force (away from the user's head and towards the door opening) on the hips of the user. This force towards the door opening is resisted by a combination of (1) the friction force between the user and the floor and (2) the friction force between the head rest 7 and the floor (if used). In some cases, the user may place a pad (ex. yoga pad) on the floor for comfort or to prevent the user from sliding on a slick floor. To increase the load in the bands 5 (or downward force on the hips), the user simply slides further away from the door opening, until the desired amount of force in the bands 5 has been achieved.

FIG. 8 is a top plan view of further alternative embodiment of the axial spinal decompression and traction device. In this embodiment, no clip is used with any type of attachment point to connect the bands 5 to the connecting elongate member 10. Instead, the bands 5 are simply wrapped around the connecting elongate member 10. In some cases, ribs or guides or securing elements 16 may be positioned on the connecting elongate member 10 in order to further secure the bands 5 in their desired locations (slightly larger than the width of the user's hips).

FIG. 9 is a top perspective view of a further alternative embodiment of the axial spinal decompression and traction device. In this embodiment, base elongate members 1 connect to the extension member 4 with a basic straight coupler 12 that connects the two ends of the members 1 and 4 but does not permit them to slide relative to one another, or telescope. A connecting elongate member 10 is then preferably connected to the extension members 4 through a pair of elbow couplers 13, preferably near 90 degrees or right angles. The elbow couplers 13 are preferably sized to accept the extension elongate member 4 on a first side and the connecting elongate member 10 on a second side.

Similar to the embodiments above, a cross-plate 3 preferably contains a pair of apertures 15 for accepting each of the extension members 4, and preferably holding them in a spaced position relative to one another. The aperture 15 is generally used to hold the extension member 4 in a position relative to the cross-plate 3. The aperture 15 can take a number of forms, in some embodiments the aperture 15 is formed by bending the cross-plate 3 into an open or closed ring-like cross-sectional shape, which provides an overall shape that is like a channel or tube which accepts the extension member 4. Generally, the extension member 4 can slide within the channel or tube defined by the aperture 15. The connecting elongate member 10 is preferably about the same length as the cross-plate 3. Optionally, the telescoping or locking mechanism 2 described herein could also be used in place of the straight coupler 12. Also optionally, the cross-plate 3 may not be used, with only the connecting elongate member 10 connecting the opposing extension members 4.

In the embodiment shown in FIG. 9, the connecting elongate member 10 preferably passes through the loops of the bands 5. The belt 6 also preferably passes through the loops of the bands 5. In this way, the bands 5 are connected to both the connecting elongate member 10 and the belt 6. Additional clips and fasteners may be used to further secure the belt 6, bands 5, and connecting elongate member 10 but this is not necessary for the invention.

The base members 1, extension members 4, optional intermediary extension members 8, connecting elongate members 10, and cross-plate 3 can be comprised of many different materials, including but not limited to plastics, wood, metals, and composite materials. The base members 1, intermediary extension members 8, and extension members 4, and connecting members 10 are preferably tubular with hollow centers but this is not required.

The bands 5 are preferably comprised of an elastomer, an elastic polymer, latex or non-latex rubber, or a rubber of some type. The bands 5 should preferably take the shape of a continuous (closed) loop but elongate straps with first and second ends can also be used. The telescoping or locking mechanism 2 can be any type of mechanical securing means such as corresponding telescoping compression rings placed on the base and extension members 1 and 4, cam locking mechanism, clamps, button clips, or pins. The telescoping or locking mechanism 2 generally uses either (1) a friction force to squeeze onto the outer diameter one of the elongate members 1 or 4 or (2) a pin/button that is inserted/removed from an aperture in the elongate member 1 or 4.

The belt 6 can be any device that secures around the waist/hips of a user. Generally, a belt that secures with hook and loop fasteners is preferable but other belts that secure using a traditional belt buckle or other securing means can be used as well. The head rest or neck support 7 is described herein as optional simply because some users may prefer the use of a rolled up towel or pillow or other home device in lieu of a specific head rest or neck support for the device or perhaps no head/neck support whatsoever.

Having shown and described a preferred embodiment of the invention, those skilled in the art will realize that many variations and modifications may be made to affect the described invention and still be within the scope of the claimed invention. Additionally, many of the elements indicated above may be altered or replaced by different elements which will provide the same result and fall within the spirit of the claimed invention. It is the intention, therefore, to limit the invention only as indicated by the scope of the claims.

I claim:

1. A kit for a back therapy device comprising:
an elongate member having a first end and a second end;
a pair of flexible bands, each band forming a continuous loop; and
a belt.

2. The kit of claim 1 further comprising:
a pair of clips for connecting the flexible bands with the belt.

3. The kit of claim 1 wherein:
the belt secures with hook and loop fasteners.

4. The kit of claim 1 further comprising:
a pair of securing elements positioned on the elongate member for securing the flexible bands to the elongate member.

5. The kit of claim 4 wherein:
the securing elements are positioned approximately shoulder width apart from one another on the elongate member.

6. The kit of claim 1 further comprising:
a pair of base elongate members;
a pair of extension elongate members;
a pair of straight couplers;
a cross-plate; and
a pair of elbow couplers.

7. The kit of claim 1 further comprising:
a pair of base elongate members;
a pair of extension elongate members;
a pair of telescoping mechanisms;
a cross-plate having a pair of apertures sized to accept the extension elongate members; and
a pair of elbow couplers.

8. The kit of claim 1 further comprising:
a pair of base elongate members;
a pair of extension elongate members;
a pair of straight couplers which are sized to accept the base elongate member on a first side and the extension elongate member on the second side;
a cross-plate; and
a pair of elbow couplers.

9. A kit for a back therapy device comprising:
a belt;
a pair of flexible bands;
a pair of base elongate members;
a pair of extension elongate members;
a pair of straight couplers;
a connecting elongate member; and
a pair of elbow couplers.

10. The kit of claim 9 wherein:
the elbow couplers are sized to accept the extension elongate member on a first side and the connecting elongate member on a second side.

11. The kit of claim 9 wherein:
the straight couplers are sized to accept the base elongate member on a first side and the extension elongate member on the second side.

12. The kit of claim 9 further comprising:
a cross-plate.

13. The kit of claim 12 wherein:
the cross-plate contains a pair of apertures with each aperture sized to accept one of the extension members.

14. A kit for a back therapy device comprising:
a belt;
a pair of flexible bands;
a pair of base elongate members;
a pair of extension elongate members;
a pair of telescoping mechanisms; and
a cross-plate having a pair of apertures with each aperture sized to accept one of the extension members.

15. The kit of claim 14 further comprising:
a connecting elongate member; and
a pair of elbow couplers.

16. The kit of claim 15 wherein:
the elbow couplers are sized to accept the extension elongate member on a first side and the connecting elongate member on a second side.

17. The kit of claim 15 wherein:
the connecting elongate member is approximately the same length as the cross-plate.

18. The kit of claim 15 wherein:
the telescoping mechanism is a set of telescoping compression rings placed on the base elongate members and extension elongate members.

19. The kit of claim 15 wherein:
the telescoping mechanism is a set of apertures and corresponding pins to be positioned at various locations on the base elongate members and extension elongate members.

20. The kit of claim 15 wherein:
the telescoping mechanism is a set of clamps placed on either the base elongate members or the extension elongate members.
